(19) United States
(12) Patent Application Publication
(10) Pub. No.: US 2026/0015019 A1
(43) Pub. Date: Jan. 15, 2026

(54) SYSTEMS AND METHODS FOR LINEAR MOTOR SYSTEM WITH MOTION CONTROL LIMITS

(71) Applicant: ROCKWELL AUTOMATION TECHNOLOGIES, INC., Mayfield Heights, OH (US)

(72) Inventors: Yuhong Huang, Acton, MA (US); Denan Fazlagic, Copenhagen (DK); Andrew S. Klibowitz, Patchogue, NY (US)

(73) Assignee: ROCKWELL AUTOMATION TECHNOLOGIES, INC., Mayfield Heights, OH (US)

(21) Appl. No.: 18/769,019

(22) Filed: Jul. 10, 2024

(51) Int. Cl. B61L 27/20; B61B 13/08; B65G 54/02

(52) U.S. Cl. CPC B61L 27/20; B61B 13/08; B65G 54/02

(57) ABSTRACT

A method for controlling operation of movers on a track including interconnected track sections includes identifying speed limits associated with a first track section of the track sections. The method also includes selecting, for each of the movers, a speed limit from the speed limits associated with the first track section. The speed limit for each mover of the movers is selected based on at least one of a characteristic of the mover or a predicted future location of the mover along the track. The method includes controlling, for each of the movers, a rate of travel of the mover along the first track section according to the selected speed limit for the mover.

### BACKGROUND

The present disclosure relates generally to a linear drive system. More specifically, the present disclosure relates to a control system for a linear drive system.

### SUMMARY

One implementation of the present disclosure is a system for controlling movement of movers, according to some embodiments. In some embodiments, the system includes a track, a mover, and processing circuitry. In some embodiments, the mover includes multiple interconnected track sections that define multiple travel paths and at least one junction at which the travel paths diverge. In some embodiments, the mover is configured to move along the track along a first travel path of the travel paths. In some embodiments, the first travel path includes at least a first track section of the track sections upstream of the junction. In some embodiments, the processing circuitry is configured to predict a future location of the mover along the track based the first travel path of the mover through the junction. In some embodiments, the predicted future location includes either a second track section or a third track section of the track sections downstream of the junction. In some embodiments, the processing circuitry is configured to control a speed of the mover at the first track section based on the predicted future location of the mover. In some embodiments, the speed of the mover is controlled to a first speed limit at the first track section if the predicted future location of the mover includes the second track section and the speed of the mover is controlled to a second speed limit at the first track section if the predicted future location of the mover includes the third track section.

In some embodiments, the first speed limit is based on a first radius of curvature of the track at the second track section and the second speed limit is based on a second radius of curvature of the track at the third track section. In some embodiments, the first speed limit is based on a predicted angular acceleration of the mover at the second track section and the second speed limit is based on a predicted angular acceleration of the mover at the third track section.

In some embodiments, the processing circuitry is configured to control the speed of the mover by controlling a velocity, an acceleration, or a jerk of the mover at the first track section based on a characteristic of the track at the second track section or the third track section. In some embodiments, the mover is a first mover. In some embodiments, the predicted future location includes the second track section, and the first mover is controlled to the first speed limit at the first track section. In some embodiments, the system further includes a second mover configured to travel along a second travel path of the travel paths. In some embodiments, the second travel path includes the first track section and the third track section. In some embodiments, the processing circuitry is configured to control a speed of the second mover at the first track section according to the second speed limit based on a characteristic of the track at a third track section.

In some embodiments, the first track section includes multiple speed limits including the first speed limit and the second speed limit. In some embodiments, the speed limits include different speed limit values based on characteristics of the track at the second track section and the third track section respectively. In some embodiments, the processing circuitry is configured to select which of the speed limits to impose at the first track section based on the predicted future location of the mover.

In some embodiments, the track includes multiple coils and the mover includes drive magnets. In some embodiments, the processing circuitry is configured to energize the coils to induce motion of the mover and control the speed of the mover. In some embodiments, the processing circuitry is configured to predict the future location of the mover based on an ordered route of the mover, or a response from the mover or a management system indicating the first travel path of the travel paths along which the mover is traveling.

Another implementation of the present disclosure is a system for controlling movement of movers, according to some embodiments. In some embodiments, the system includes a track, a mover, and processing circuitry. In some embodiments, the track includes interconnected track sections defining a travel path. In some embodiments, the mover is configured to move along the track along the travel path. In some embodiments, the processing circuitry is configured to select a speed limit for the mover based on a payload of the mover. In some embodiments, the speed limit is selected from multiple speed limits associated with a first track section of the track sections and corresponding to different payloads of the mover. In some embodiments, the processing circuitry is configured to control a speed of the mover at the first track section according to the selected speed limit based on the payload of the mover.

In some embodiments, the payload includes a weight of the mover, a size of the mover, or a quantity of contents of the mover. In some embodiments, the speed limits associated with the first track section include speed limit values for various values of the payload of the mover. In some embodiments, the speed limits have speed limit values for the various values of the payload of the mover such that tipping of the mover is reduced when the mover is controlled according to a corresponding one of the speed limits.

In some embodiments, the payload of the mover is obtained from a management system that manages orders fulfilled by the mover, or from a load observer. In some embodiments, the speed limits have speed limit values that reduce tipping of the mover based on both the payload of the mover and a radius of curvature at the first zone or a predicted future zone of the track towards which the mover is traveling.

In some embodiments, the track includes coils and the mover includes drive magnets. In some embodiments, the processing circuitry is configured to energize the plurality of coils to induce motion of the mover and control the speed of the mover. In some embodiments, the processing circuitry is configured to control the speed of the mover by controlling a velocity, an acceleration, or a jerk of the mover at the first zone based on the one of the speed limits associated with the first zone.

Another implementation of the present disclosure is a method for controlling operation of movers on a track including interconnected track sections, according to some embodiments. In some embodiments, the method includes identifying speed limits associated with a first track section of the track sections. In some embodiments, the method includes selecting, for each of the movers, a speed limit from the speed limits associated with the first track section. In some embodiments, the speed limit for each mover of the movers is selected based on at least one of a characteristic of the mover or a predicted future location of the mover along the track. In some embodiments, the method includes controlling, for each of the movers, a rate of travel of the mover along the first track section according to the selected speed limit for the mover.

In some embodiments, the characteristic of the mover includes a payload of the mover. In some embodiments, the predicted future location of the mover includes either a second track section or a third track section of the track sections and is selected based on a travel path of the mover. In some embodiments, controlling energization of coils of the track induces motion of the movers to control the rate of travel of each of the movers.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic representation of an exemplary control system for a linear drive system, according to some embodiments.

FIG. 2 is a sectional view of a mover and track segment included in the linear drive system taken at 2-2 of FIG. 1, according to some embodiments.

FIG. 3 is a bottom plan view of the mover of FIG. 2, according to some embodiments.

FIG. 4 is a partial side cutaway view of the mover and track segment of FIG. 2, according to some embodiments.

FIG. 5 is a sectional view of another embodiment of a mover and track segment included in the linear drive system taken at 2-2 of FIG. 1, according to some embodiments.

FIG. 6 is a partial side cutaway view of the mover and track segment of FIG. 5, according to some embodiments.

FIG. 7 is a partial top cutaway view of the mover and track segment of FIG. 2, according to some embodiments.

FIG. 8 is a block diagram representation of the control system of FIG. 1, according to some embodiments.

FIG. 9 is a perspective view of a mover for the linear drive system of FIG. 1, according to some embodiments.

FIG. 10 is a diagram of a track system including the mover and track segment of FIG. 2 with multiple zones or segments and multiple paths, according to some embodiments.

FIG. 11 is a block diagram of a control system for the track system of FIG. 10 to provide various speed limits for various track segments, according to some embodiments.

FIG. 12 is a flow diagram of a process for controlling a linear drive system using speed limits based on a predicted future location or travel path of movers, according to some embodiments.

FIG. 13 is a flow diagram of a process for controlling a linear drive system using speed limits based on a payload of movers, according to some embodiments.

FIG. 14 is a flow diagram of a process for controlling a linear drive system to control a rate of travel of multiple movers using speed limits, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a linear drive system includes a track having multiple track segments, and movers that travel along the track. The track segments can each include an array of drive coils, and each of the movers may include an array of magnets. The drive coils can be sequentially activated in order to induce transportation of the movers along the track. The linear drive system may also include a controller that applies speed limits for the movers. The speed limits can be applied in real-time to multiple of the movers based on speed limits obtained from a database of speed limits. The speed limits can be retrieved by the controller based on an identification of which segments the movers are currently located or are approaching. One or more of the track segments (e.g., curved track segments, junction segments that are operable to divert movers between different paths or track segments, etc.) may include multiple speed limits that can be applied to various movers as the movers travel along the track segments. The controller can select, from the multiple speed limits, a speed limit to be applied to a mover that is approaching or traveling over the track segments.

The speed limit can be selected from the multiple speed limits based on a characteristic of the mover (e.g., a payload of the mover), or a predicted future location of the mover (e.g., which of multiple directions the mover will be diverted through as the mover travels through the junction segment). Advantageously, applying the speed limits based on the payload and the predicted future locations can improve throughput of the linear drive system by reducing traffic jams or pileups on the track. The speed limits based on the predicted future location of the movers also facilitates allowing movers that will be transferred straight through junction segments to travel at a higher rate of speed than movers that will be diverted around a curve through the junction segments, thereby improving throughput of the linear drive system. The application of the speed limits based on the payload of the movers can also reduce a likelihood that the movers will tip or spill their contents. The speed limits can also facilitate improved smoothness of the travel of the movers. Applying the speed limits based on the predicted future location and payload of the movers can improve throughput of the movers by reducing an average throughput of 25 seconds per product (e.g., silicone wafer) carried by the movers.

### System Overview

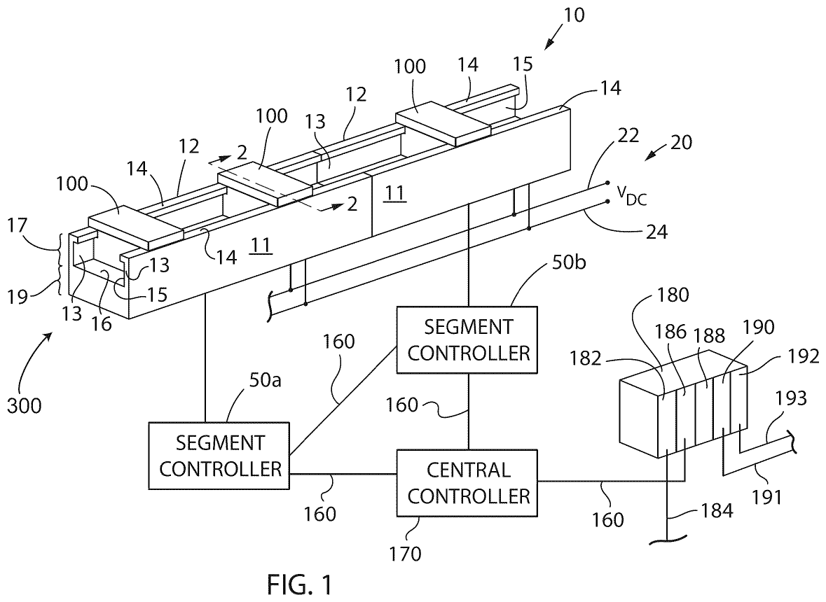

Referring to FIGS. 1-4, a transport system (e.g., a linear drive system 300, an induction drive system, etc.) for moving articles or products includes a track 10 having multiple segments 12. In some embodiments, multiple segments 12 are coupled with each other and arranged end-to-end (e.g., serially) to define the overall track configuration. The segments 12 may be straight segments having generally the same length. In some embodiments, the segments 12 have various sizes, lengths, and shapes and can be coupled with each other to form the track 10 according to a desired shape (e.g., an elliptical path, a circular path, etc.). In some embodiments, track segments 12 may be coupled with each other to form a generally closed loop that supports one or more movers 100 (e.g., carts, trains, vehicles, movable blocks, etc.) that are movable along the track 10. The track 10 is illustrated in a horizontal plane. For convenience, the horizontal orientation of the track 10 shown in FIG. 1 will be discussed herein. Terms such as upper, lower, inner, and outer will be used with respect to the illustrated track orientation. These terms are relational with respect to the illustrated track and are not intended to be limiting. It is understood that the track may be installed in different orientations, such as sloped or vertical, and include different shaped segments including, but not limited to, straight segments, inward bends, outward bends, up slopes, down slopes and various combinations thereof. The width of the track 10 may be greater in either the horizontal or vertical direction according to application requirements. The movers 100 will travel along the track and take various orientations according to the configuration of the track 10 and the relationships discussed herein may vary accordingly.

According to some embodiments, each track segment 12 includes an upper portion 17 and a lower portion 19. The upper portion 17 is configured to couple with (e.g., slidably, translatably, etc.) and support the movers 100, according to some embodiments. In some embodiments, the lower portion 19 is configured to house one or more control elements. In some embodiments, the upper portion 17 includes a generally u-shaped channel 15 extending longitudinally along the upper portion 17 of each segment. The channel 15 includes a bottom surface 16 and a pair of side walls 13, according to some embodiments. In some embodiments, each side wall 13 includes a rail 14 extending along an upper edge of the side wall 13. The bottom surface 16, side walls 13, and rails 14 may extend longitudinally along the track segment 12 and define a guideway along which the movers 100 travel. In some embodiments, the surfaces of the channel 15 (i.e., the bottom surface 16, side walls 13 and rails 14) are planar surfaces made of a low friction material along which movers 100 may slide. In some embodiments, the contacting surfaces of the movers 100 may also be planar and made of a low friction material. In some embodiments, the surface may be, for example, nylon, Teflon®, aluminum, stainless steel, etc. In some embodiments, the contacting surfaces of the movers 100 are provided as a slidable bearing which may degrade over time. In some embodiments, the hardness of the surfaces on the track segment 12 are greater than the contacting surface of the movers 100 such that the contacting surfaces of the movers 100 wear faster than the surface of the track segment 12. In some embodiments, the contacting surfaces of the movers 100 may be removably mounted to the housing 11 of the mover 100 such that they may be replaced if the wear exceeds a predefined amount. In some embodiments, the movers 100 may include low-friction rollers to engage the surfaces of the track segment 12. The low-friction rollers may include bearings. In some embodiments, the surfaces of the channel 15 may include different cross-sectional forms with the mover 100 including complementary sectional forms. In some embodiments, the track segment 12 and mover have other combinations of shapes and construction such that the mover 100 can interface with (e.g., rest upon, hang upon, etc.) the track segments 12 and travel along the track segments 12.

In some embodiments, each mover 100 is configured to slide along the channel 15 as it is propelled by a linear drive system 300. The mover 100 includes a body 102 configured to fit within the channel 15, according to some embodiments. The body 102 includes a lower surface 106, configured to engage the bottom surface 16 of the channel, and side surfaces 108 configured to engage the side walls 13 of the channel, according to some embodiments. In some embodiments, the mover 100 further includes a shoulder 105 extending inward from each of the side surfaces 108. In some embodiments, the shoulder 105 has a width equal to or greater than the width of the rail 14 protruding into the channel. In some embodiments, a neck of the mover extends upward to a top surface 104 of the body 102. In some embodiments, the neck extends for the thickness of the rails such that the top surface 104 of the body 102 is generally parallel with the upper surface 32 of each rail 14. In some embodiments, the mover 100 further includes a platform 110 secured to the top surface 104 of the body 102. In some embodiments, the platform 110 is generally square and the width of the platform 110 is greater than the width between the rails 14. In some embodiments, the lower surface 114 of the platform 110, an outer surface of the neck, and an upper surface of the shoulder 105 define a channel 115 in which the rail 14 runs. In some embodiments, the channel 115 serves as a guide to direct the mover 100 along the track. In some embodiments, one or more platforms or attachments of various shapes may be secured to the top surface 104 of the body 102. Further, various workpieces, clips, fixtures, and the like may be mounted on the top 112 of each platform 110 for engagement with a product to be carried along the track by the mover 100. The platform 110 and any workpiece, clip, fixture, or other attachment present on the platform may define, at least in part, a load present on the mover 100.

The mover 100 is induced or driven to move (e.g., travel) along the track 10 by a linear drive system 300, according to some embodiments. The linear drive system 300 is incorporated in part on each mover 100 and in part within each track segment 12, according to some embodiments. One or more drive magnets 120 are mounted to each mover 100. With reference to FIG. 3, the drive magnets 120 are arranged in a block on the lower surface of each mover. The drive magnets 120 include positive magnet segments 122, having a north pole, N, facing outward from the mover and negative magnet segments 124, having a south pole, S, facing outward from the mover, according to some embodiments. In some embodiments, two positive magnet segments 122 are located on the outer sides of the set of magnets and two negative magnet segments 124 are located between the two positive magnet segments 122. In some embodiments, the positive and negative motor segments are placed in an alternating configuration. In some embodiments, a single negative magnet segment 124 may be located between the positive magnet segments 122. Various other configurations of the drive magnets 120 may be utilized according to some embodiments. In some embodiments, the positive magnet segments 122 are half-width magnets while the negative magnet segments 124 are full width magnets. While FIG. 3 illustrates a single cycle magnet array, the mover 100 may also or alternatively be driven to move along the track 10 by drive magnets 120 arranged in a two cycle array (e.g., a stack of magnets alternating between full north pole N magnets and half segment south pole S magnets).

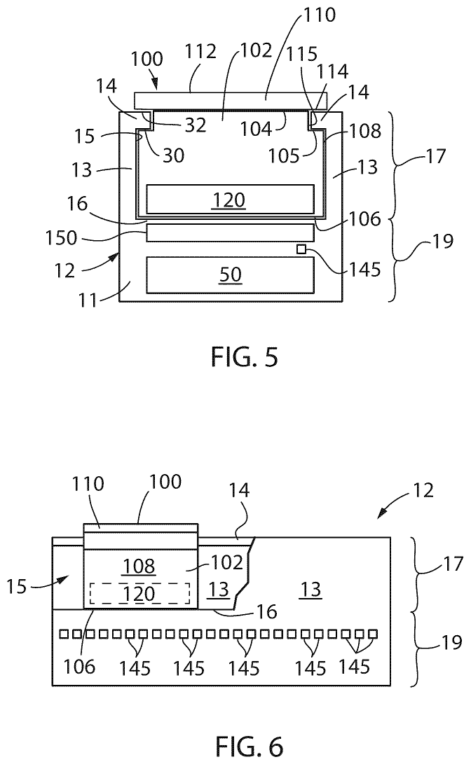

The linear drive system 300 further includes a series of coils 150 spaced along the length of the track segment 12. With reference also to FIG. 5, the coils 150 may be positioned within a housing 11 for the track segment 12 and below the bottom surface 16 of the channel 15. The coils 150 are energized sequentially according to the configuration of the drive magnets 120 present on the movers 100. The sequential energization of the coils 150 generates a moving electromagnetic field that interacts with the magnetic field of the drive magnets 120 to propel each mover 100 along the track segment 12.

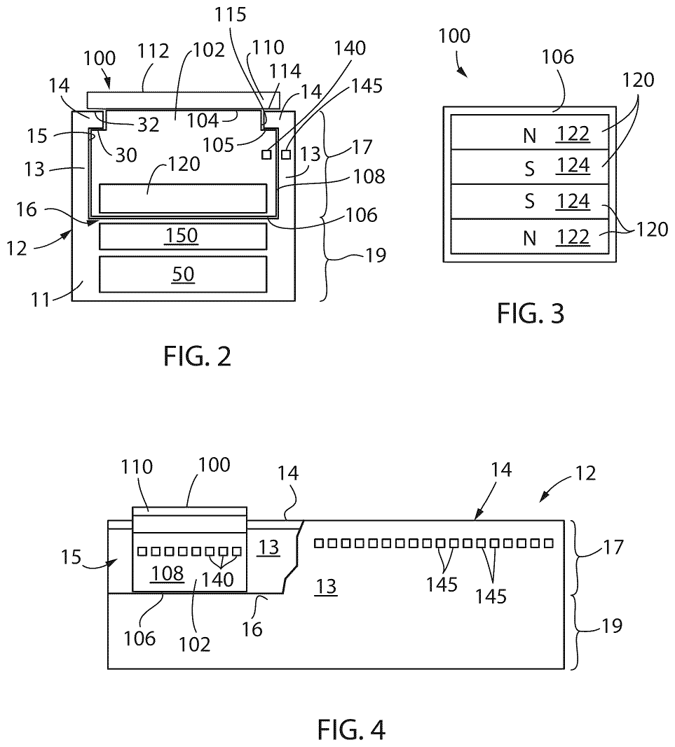

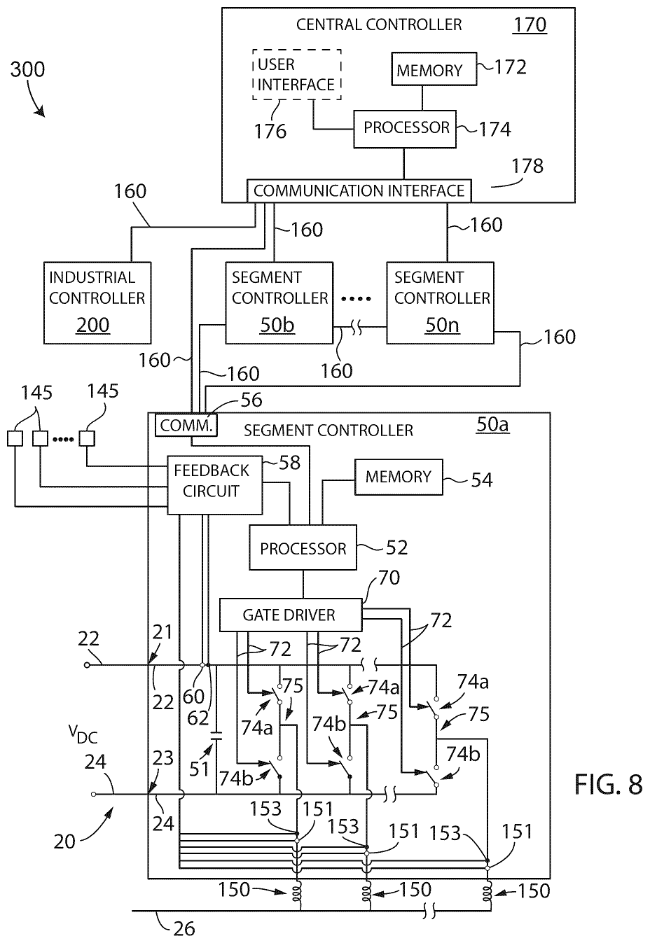

A segment controller 50 is provided within each track segment 12 to control the linear drive system 300 and to achieve the desired motion of each mover 100 along the track segment 12. Although illustrated in FIG. 1 as blocks external to the track segments 12, the arrangement is to facilitate illustration of interconnects between controllers. As shown in FIG. 2, it is contemplated that each segment controller 50 may be mounted in the lower portion 19 of the track segment 12. A first segment controller 50a is shown with a first track segment, and a second segment controller 50b is shown with a second track segment. It is contemplated that any number “n” of segment controllers 50n (see FIG. 8) may be included in the linear drive system 300. Each segment controller 50 is in communication with a central controller 170 which is, in turn, in communication with an industrial controller 200. The industrial controller 200 may be, for example, a programmable logic controller (PLC) configured to control elements of a process line stationed along the track 10. The process line may be configured, for example, to fill and label boxes, bottles, or other containers loaded onto or held by the movers 100 as they travel along the line. In other embodiments, robotic assembly stations may perform various assembly and/or machining tasks on workpieces carried along by the movers 100. The exemplary industrial controller 200 includes: a power supply 182 with a power cable 184 connected, for example, to a utility power supply; a communication module 186 connected by a network medium 160 to the central controller 170; a processor module 188; an input module 190 receiving input signals 191 from sensors or other devices along the process line; and an output module 192 transmitting control signals 193 to controlled devices, actuators, and the like along the process line. The processor module 188 may identify when a mover 100 is required at a particular location and may monitor sensors, such as proximity sensors, position switches, or the like to verify that the mover 100 is at a desired location. The processor module 188 transmits the desired locations of each mover 100 to a central controller 170 where the central controller 170 operates to generate commands for each segment controller 50.

With reference also to FIG. 8, the central controller 170 includes a processor 174 and a memory device 172. It is contemplated that the processor 174 and memory device 172 may each be a single electronic device or formed from multiple devices. The processor 174 may be a microprocessor. In some embodiments, the processor 174 and/or the memory device 172 may be integrated on a field programmable gate array (FPGA) or an application specific integrated circuit (ASIC). The memory device 172 may include volatile memory, non-volatile memory, or a combination thereof. An optional user interface 176 may be provided for an operator to configure the central controller 170 and to load or configure desired motion profiles for the movers 100 on the central controller 170. In some embodiments, the configuration may be performed via a remote device connected via a network and a communication interface 178 to the central controller 170. It is contemplated that the system controller 170 and user interface 176 may be a single device, such as a laptop, notebook, tablet or other mobile computing device. In some embodiments, the user interface 176 may include one or more separate devices such as a keyboard, mouse, display, touchscreen, interface port, removable storage medium or medium reader and the like for receiving information from and displaying information to a user. In some embodiments, the system controller 170 and user interface may be an industrial computer mounted within a control cabinet and configured to withstand harsh operating environments. In some embodiments, still other combinations of computing devices and peripherals may be utilized or incorporated into the system controller 170 and user interface 176.

The central controller 170 includes one or more programs stored in the memory device 172 for execution by the processor 174. The system controller 170 receives a desired position from the industrial controller 200 and determines one or more motion profiles for the movers 100 to follow along the track 10. A program executing on the processor 174 is in communication with each segment controller 50 on each track segment via a network medium 160. The system controller 170 may transfer a desired motion profile to each segment controller 50. In some embodiments, the system controller 170 may be configured to transfer the information from the industrial controller 200 identifying one or more desired movers 100 to be positioned at or moved along the track segment 12, and the segment controller 50 may determine the appropriate motion profile for each mover 100.

A position feedback system provides knowledge of the location of each mover 100 along the length of the track segment 12 to the segment controller 50. According to some embodiments, illustrated in FIGS. 2 and 4, the position feedback system includes one or more position magnets 140 mounted to the mover 100 and an array of sensors 145 spaced along the side wall 13 of the track segment 12. The sensors 145 are positioned such that each of the position magnets 140 are proximate to the sensor as the mover 100 passes each sensor 145. The sensors 145 are a suitable magnetic field detector including, for example, a Hall Effect sensor, a magneto-diode, an anisotropic magnetoresistive (AMR) device, a giant magnetoresistive (GMR) device, a tunnel magnetoresistance (TMR) device, fluxgate sensor, or other microelectromechanical (MEMS) device configured to generate an electrical signal corresponding to the presence of a magnetic field. The magnetic field sensor 145 outputs a feedback signal provided to the segment controller 50 for the corresponding track segment 12 on which the sensor 145 is mounted. The feedback signal may be an analog signal provided to a feedback circuit 58 which, in turn, provides a signal to the processor 52 corresponding to the magnet 140 passing the sensor 145.

According to some embodiments, illustrated in FIGS. 5 and 6, the position feedback system utilizes the drive magnets 120 as position magnets. Position sensors 145 are positioned along the track segment 12 at a location suitable to detect the magnetic field generated by the drive magnets 120. According to the illustrated embodiment, the position sensors 145 are located below the coils 150. In some embodiments, the position sensors 145 may be interspersed with the coils 150 and located, for example, in the center of a coil or between adjacent coils. According to still another embodiment, the position sensors 145 may be positioned within the upper portion 17 of the track segment 12 and near the bottom surface 16 of the channel 15 to be aligned with the drive magnets 120 as each mover 100 travels along the tracks segment 12.

The segment controller 50 also includes a communication interface 56 that receives communications from the central controller 170 and/or from adjacent segment controllers 50. The communication interface 56 extracts data from the message packets on the industrial network and passes the data to a processor 52 executing in the segment controller 50. The processor may be a microprocessor. In some embodiments, the processor 52 and/or a memory device 54 within the segment controller 50 may be integrated on a field programmable gate array (FPGA) or an application specific integrated circuit (ASIC). It is contemplated that the processor 52 and memory device 54 may each be a single electronic device or formed from multiple devices. The memory device 54 may include volatile memory, non-volatile memory, or a combination thereof. The segment controller 50 receives the motion profile or desired motion of the movers 100 and utilizes the motion commands to control movers 100 along the track segment 12 controlled by that system controller 30.

Each segment controller 50 generates switching signals to generate a desired current and/or voltage at each coil 150 in the track segment 12 to achieve the desired motion of the movers 100. The switching signals 72 control operation of switching devices 74 for the segment controller 50. According to the illustrated embodiment, the segment controller 50 includes a dedicated gate driver module 70 which receives command signals from the processor 52, such as a desired voltage and/or current to be generated in each coil 150, and generates the switching signals 72. In some embodiments, the processor 52 may incorporate the functions of the gate driver module 70 and directly generate the switching signals 72. The switching devices 74 may be a solid-state device that is activated by the switching signal, including, but not limited to, transistors, thyristors, or silicon-controlled rectifiers.

According to the illustrated embodiment, the track receives power from a distributed DC voltage. A DC bus 20 receives a DC voltage, VDC, from a DC supply and conducts the DC voltage to each track segment 12. The illustrated DC bus 20 includes two voltage rails 22, 24 across which the DC voltage is present. The DC supply may include, for example, a rectifier front end configured to receive a single or multi phase AC voltage at an input and to convert the AC voltage to the DC voltage. It is contemplated that the rectifier section may be passive, including a diode bridge or, active, including, for example, transistors, thyristors, silicon-controlled rectifiers, or other controlled solid-state devices. Although illustrated external to the track segment 12, it is contemplated that the DC bus 20 would extend within the lower portion 19 of the track segment. Each track segment 12 includes connectors to which either the DC supply or another track segment may be connected such that the DC bus 20 may extend for the length of the track 10. In some embodiments, each track segment 12 may be configured to include a rectifier section (not shown) and receive an AC voltage input. The rectifier section in each track segment 12 may convert the AC voltage to a DC voltage utilized by the corresponding track segment.

The DC voltage from the DC bus 20 is provided at the input terminals 21, 23 to a power section for the segment controller. A first voltage potential is present at the first input terminal 21 and a second voltage potential is present at the second input terminal 23. The DC bus extends into the power section defining a positive rail 22 and a negative rail 24 within the segment controller. The terms positive and negative are used for reference herein and are not meant to be limiting. It is contemplated that the polarity of the DC voltage present between the input terminals 21, 23 may be negative, such that the potential on the negative rail 24 is greater than the potential on the positive rail 22. Each of the voltage rails 22, 24 are configured to conduct a DC voltage having a desired potential, according to application requirements. According to some embodiments, the positive rail 22 may have a DC voltage at a positive potential and the negative rail 24 may have a DC voltage at ground potential. In some embodiments, the positive rail 22 may have a DC voltage at ground potential and the negative rail 24 may have a DC voltage at a negative potential. According to some embodiments, the positive rail 22 may have a first DC voltage at a positive potential with respect to the ground potential and the negative rail 24 may have a second DC voltage at a negative potential with respect to the ground potential. The resulting DC voltage potential between the two rails 22, 24 is the difference between the potential present on the positive rail 22 and the negative rail 24.

It is further contemplated that the DC supply may include a third voltage rail 26 having a third voltage potential. According to some embodiments, the positive rail 22 has a positive voltage potential with respect to ground, the negative rail 24 has a negative voltage potential with respect to ground, and the third voltage rail 26 is maintained at a ground potential. In some embodiments, the negative voltage rail 24 may be at a ground potential, the positive voltage rail 22 may be at a first positive voltage potential with respect to ground, and the third voltage rail 26 may be at a second positive voltage potential with respect to ground, where the second positive voltage potential is approximately one half the magnitude of the first positive voltage potential. With such a split voltage DC bus, two of the switching devices 74 may be used in pairs to control operation of one coil 150 by alternately provide positive or negative voltages to one the coils 150.

The power section in each segment controller 50 may include multiple legs, where each leg is connected in parallel between the positive rail 22 and the negative rail 24. According to the illustrated embodiment, three legs are shown. However, the number of legs may vary and will correspond to the number of coils 150 extending along the track segment 12. Each leg includes a first switching device 74a and a second switching device 74b connected in series between the positive rail 22 and the negative rail 24 with a common connection 75 between the first and second switching devices 74a, 74b. The first switching device 74a in each leg may also be referred to herein as an upper switch, and the second switching device 74b in each leg may also be referred to herein as a lower switch. The terms upper and lower are relational only with respect to the schematic representation and are not intended to denote any particular physical relationship between the first and second switching devices 74a, 74b. The switching devices 74 include, for example, power semiconductor devices such as transistors, thyristors, and silicon controlled rectifiers, which receive the switching signals 72 to turn on and/or off. Each of switching devices may further include a diode connected in a reverse parallel manner between the common connection 75 and either the positive or negative rail 22, 24.

The processor 52 also receives feedback signals from sensors providing an indication of the operating conditions within the power segment or of the operating conditions of a coil 150 connected to the power segment. According to the illustrated embodiment, the power segment includes a voltage sensor 62 and a current sensor 60 at the input of the power segment. The voltage sensor 62 generates a voltage feedback signal and the current sensor 60 generates a current feedback signal, where each feedback signal corresponds to the operating conditions on the positive rail 22. The segment controller 50 also receives feedback signals corresponding to the operation of coils 150 connected to the power segment. A voltage sensor 153 and a current sensor 151 are connected in series with the coils 150 at each output of the power section. The voltage sensor 153 generates a voltage feedback signal and the current sensor 151 generates a current feedback signal, where each feedback signal corresponds to the operating condition of the corresponding coil 150. The processor 52 executes a program stored on the memory device 54 to regulate the current and/or voltage supplied to each coil and the processor 52 and/or gate driver module 70 generates switching signals 72 which selectively enable/disable each of the switching devices 74 to achieve the desired current and/or voltage in each coil 150. The energized coils 150 create an electromagnetic field that interacts with the drive magnets 120 on each mover 100 to control motion of the movers 100 along the track segment 12.

In operation, the load may vary on a mover 100 as the mover travels along the track. As previously discussed, the mover 100 includes a platform 110 secured to the top surface 104 of the body 102 of the mover 100. It is contemplated that platforms or attachments of various shapes may be secured to the top surface 104 of the body 102. Further, various workpieces, clips, fixtures, and the like may be mounted on the top of each platform 110 for engagement with a product to be carried along the track by the mover 100. The platform 110 and any workpiece, clip, fixture, or other attachment present on the platform may define, at least in part, a load present on the mover 100. For a given system, each mover 100 may have the same platform and/or attachments to uniformly interact with identical product being loaded on and off the mover 100. The product may constitute an additional load and may vary at different locations along a track. For example, a mover 100 may initially have no additional load present. At a first station, a container, such as a box, bottle, or the like may be loaded on to the mover 100. At a second station, product may be partially or fully loaded into the container. At additional stations, steps, such as additional loading, closing, labeling, and the like may be taken that further alter the load present on each mover. At a final station, the load may be removed and the mover 100 returns to the initial station. According to the exemplary application, the load varies along each section of track after additional packaging and/or product is placed on the mover 100. In addition, wear or damage on contacting surfaces, bearings, and the like may cause variations in the loading between movers 100 or variations in loading for a single mover over time.

In order to optimize performance of the linear drive system 300, it is desirable to characterize loads present on the movers 100 at various locations along the track. According to some embodiments, the segment controller 50 may be configured to provide a characterization of a load present on each mover 100 as it travels along the corresponding track segment 12. The mover 100 is initially positioned at a point of interest along a track segment 12. The expected load to be present on the mover 100 may also be included on the mover. For example, if a container and/or product is present on the mover 100 during operation, an appropriate container and/or product may be loaded on the mover 100 prior to characterization. As will be discussed in more detail below, the segment controller 50 then executes a characterization module to obtain a frequency response corresponding to performance of a mover 100 at a location and with an expected load. In some embodiments, the segment controller 50 may sample data and transmit stored data to the central controller 170 or to another remote processing device to obtain the frequency response corresponding to performance of the mover 100 at a location and with an expected load.

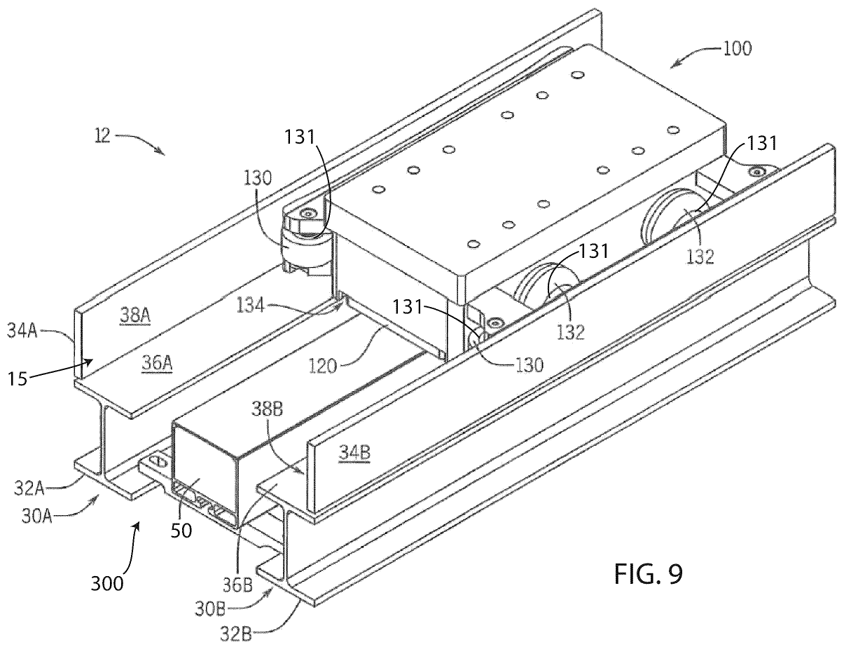

Referring to FIG. 9, the mover 100 may include wheels 130, 132 configured to roll along one or more surfaces (e.g., both a horizontal surface and a vertical surface). For example, a first set of wheels 130 may mounted horizontally and configured to engage inner, vertical surfaces 38A and 38B of rails 30A and 30B of the track segments 12 (e.g., on guiding segments 34A and 34B of rails 30A and 30B). A second set of wheels 132 may be mounted vertically and configured to engage inner, horizontal surfaces 36A and 36B of each of the rails 30A and 30B. In some embodiments, the two sets of wheels 132 are used to align the mover 100 within the channel 15 of the track segment 12 as the mover 100 travels along the track 10. In some embodiments, only one set of wheels 132 are used to facilitate transportation of the mover 100 along the track 10. In some embodiments, the wheels 132 and 130 each include a corresponding bearing 131 that is configured to facilitate improved rotation of the wheels 132 and 130.

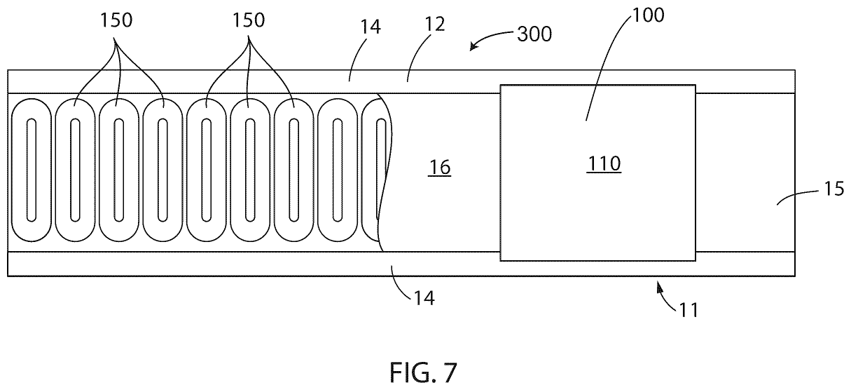

Referring to FIGS. 1-9, the track 10, the linear drive system 300, a control system for the linear drive system 300, any of the movers 100 of the linear drive system 300, or any diagnostic techniques for the linear drive system 300 may be the same as or similar to U.S. application Ser. No. 15/702,983, now U.S. Pat. No. 11,165,372 B2, U.S. application Ser. No. 15/710,977, now U.S. Pat. No. 10,442,637 B2, U.S. application Ser. No. 16/015,699, now U.S. Pat. No. 10,432,117 B1, U.S. application Ser. No. 15/701,578, now U.S. Pat. No. 10,562,715 B2, and/or U.S. application Ser. No. 17/355,714, the entire disclosures of all of which are incorporated by reference herein.

### Speed Limit System

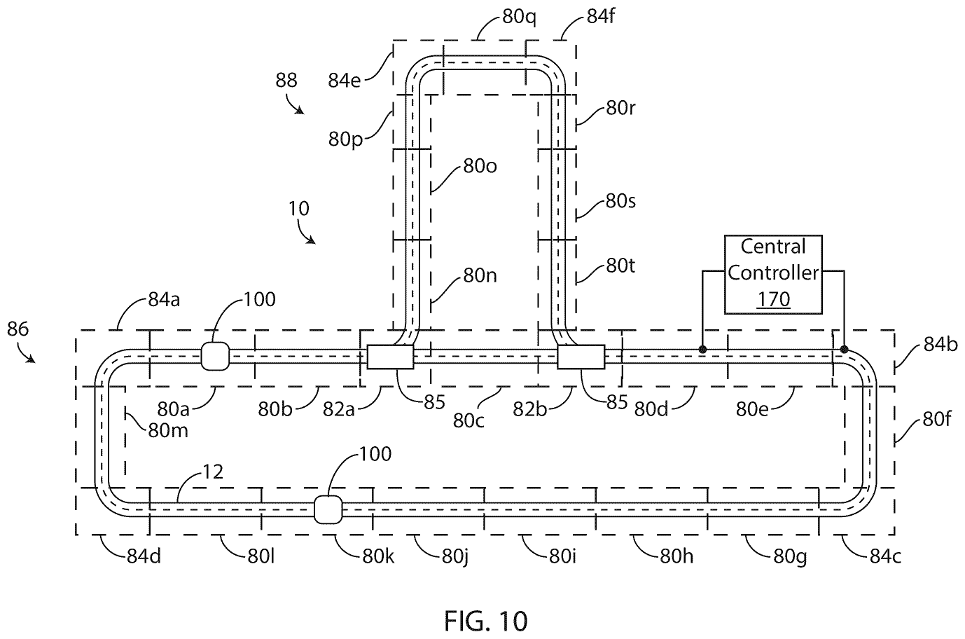

Referring to FIG. 10, among others, the track 10 includes multiple track segments 12 including straight segments 80, corner or curved segments 84, and junction segments 82, according to some embodiments. The straight segments 80, the curved segments 84, and the junction segments 82 interlock with each other in order to define the track 10. The junction segments 82 join two or more track segments 12 and include junction members 85, according to some embodiments. The junction members 85 are operable between various positions or states (e.g., physical or electromagnetic) in order to direct movers 100 between various track segments 12 or along different paths.

The track 10 can include a first path 86 (i.e., the lower loop shown in FIG. 10) defined by curved segment 84a, straight segment 80a, straight segment 80b, junction segment 82a straight segment 80c, junction segment 82b, straight segment 80d, straight segment 80e, curved segment 84b, straight segment 80f, curved segment 84c, straight segment 80g, straight segment 80h, straight segment 80i, straight segment 80j, straight segment 80k, curved segment 84d, and straight segment 80m. The track 10 can also include a second path 88 (i.e., the upper branch shown in FIG. 10) defined by junction segment 82a, straight segment 80n, straight segment 80o, straight segment 80p, curved segment 84e, straight segment 80q, curved segment 84f, straight segment 80r, straight segment 80s, straight segment 80t, and junction segment 82b. The junction segment 82a or the junction segment 82b can be operated between different positions or states to direct movers 100 along the first path 86 or the second path 88. It should be understood that the first path 86 and the second path 88 may be defined by more or fewer track segments 12 than shown. The first path 86 and the second path 88 are provided for illustrative purposes only and should not be understood as limiting. Further, the track 10 may include any configuration of paths and junction segments 82 to re-direct movers 100 between various paths. For example, the track 10 may include junction segments 82 that direct movers 100 between two, three, four, etc., other track segments and paths. The junction segments 82 define points at which track interconnected track segments 12 diverge or converge with each other to define various travel paths.

In some embodiments, the paths 86, 88, or other potential paths along the track 10 are at least partially overlapping such that a given mover 100 can be located on multiple paths at the same time. Similarly, a given track segment 12 can be part of multiple different paths. Multiple paths along the track 10 may converge or diverge at the junction segments 82 and may be defined by the planned (e.g., scheduled, predicted, programmed, etc.) route a given mover 100 will take along the track 10. Some paths may form closed loops (e.g., path 86), whereas other paths may form open or closed branches (e.g., path 88) that extend from other paths of the track 10. Advantageously, the speed limits imposed on a mover 100 may depend on the path of the mover (e.g., the predicted future location of the mover 100) and/or other attributes of the mover 100 (e.g., payload, weight, etc.) rather than being based exclusively on the particular track segment 12 on which the mover 100 is currently located.

Before discussing the speed limits in detail, it is noted that the term “upstream” as used herein refers to a location along the track 10 (e.g., a track segment 12 or portion of a track segment 12) which a given mover 100 passes through before reaching a “downstream” location along the track 10. For example, if the movers 100 travel in a generally clockwise direction along the track 10 from the perspective shown in FIG. 10, the straight segment 80b is located upstream of the junction member 85 and/or the junction segment 82a, whereas the straight segments 80n and 80c are located downstream of the junction member 85 and/or the junction segment 82a. Similarly, the portion of the junction segment 82a on which the mover is located immediately before reaching the junction member 85 is located upstream of the junction member 85, whereas the portion of the junction segment 82a on which the mover is located immediately after passing through the junction member 85 is located downstream of the junction member 85. For tracks 10 or paths which form closed loops, “upstream” and “downstream” locations relative to a given junction can be defined based on whether the location is closer to the upstream end(s) of the junction or closer to the downstream end(s) of the junction.

Each of the track segments 12 are associated with multiple speed limits. In particular, the junction segments 82 can be associated with speed limits corresponding to a predicted future path of one of the movers 100 approaching the junction segments 82. For example, the junction segment 82a or the straight segment 80b upstream of the junction segment 82a can be associated with both a first speed limit and a second speed limit. The first speed limit is used to control a rate of motion of movers 100 that are approaching the junction 82a and are predicted to travel along the second path 88 (e.g., to be diverted by the junction segment 82a to the straight segment 80n). The second speed limit is used to control the rate of motion of movers 100 that are approaching the junction 82a and are predicted to travel along the first path 86 (e.g., to pass straight through the junction segment 82a to the straight segment 80c). The values of the first speed limit and the second speed limit can be set or determined (e.g., by the central controller 170) based on a radius of curvature, an expected angular momentum, etc., that the movers 100 will experience when traveling over the junction segment 82a and being diverted to the second path 88 or to travel to the first path 86. The speed limits are applied to control the movers 100 based on the predicted future location of the movers 100 (e.g., whether the mover 100 is predicted to be diverted by the junction segment 82a to the straight segment 80n, or whether the mover 100 is predicted to pass straight through the junction segment 82a to the straight segment 80c).

The speed limits can be associated with and applied at track segments 12 (e.g., track sections) that are upstream of the junction segment 82a such that the rate of travel (e.g., rate of motion, speed, acceleration, or a derivative of position with respect to time that is higher than acceleration namely a “jerk limit”) of the movers 100 is controlled before the movers 100 enter the junction segment 82a. Additionally or alternatively, the first and the second speed limits can be associated with and applied at the junction segments 82. Applying a different speed limit to control velocity, acceleration, or a jerk of the movers 100 based on which of multiple travel paths the movers 100 are predicted to travel along reduces a likelihood of the movers 100 tipping when being diverted by the junction segments 82 and improves throughput of the movers 100 on the track 10.

It should be understood that any number of speed limits can be associated with the track segments 10 upstream of the junction segments 82 corresponding to a number of potential routes or travel paths of the movers 100 exiting the junction segment 82. For example, a junction segment that is configured to divert the movers 100 between three paths (e.g., divert the movers 100 to the left, divert the movers 100 to the right, or allow the movers 100 to travel straight through) may include three speed limits having values corresponding to a radius of curvature of the three paths. In some embodiments, the speed limit applied for movers 100 that are passing straight through the junction segment 82 without being diverted along a curved track portion have a higher speed limit than speed limits applied for movers 100 that are predicted to be diverted by the junction segment 82. In particular, movers 100 that are not predicted to experience angular acceleration due to being diverted by the junction segment 82 (e.g., movers 100 that will travel straight through the junction segment 82) can be controlled to pass through the junction segment 82 at a higher velocity than movers 100 that will be diverted by the junction segment 82 to travel along a curved track section.

Referring still to FIG. 10, among others, the curved track segments 84, or track segments 12 upstream of the curved track segments 84 can be associated with multiple speed limits. The multiple speed limits can be used to control travel of the movers 100 based on a payload of the movers 100. For example, the straight track segment 80l that is upstream of the curved track segment 84d can include multiple speed limits corresponding to different payloads of movers 100. The speed limits can have values that are determined or set based on both values of payloads of movers 100 and a radius of curvature of the downstream curved track segment 84d. For example, a mover 100 with a larger payload may benefit from having a lower speed limit assigned when approaching and traveling around the curved track segment 84d in order to reduce a likelihood that the mover 100 will tip. The payload can include a weight of the mover 100, a size of the mover 100, or a quantity of product, contents, or components carried by the mover 100. The payload can also include a type of product that is carried by the mover 100. For example, a higher value product may be associated with a higher value of payload such that the mover 100 is operated according to a lower speed limit to reduce a likelihood of tipping or spilling the high value product.

The payload of the mover 100 can be determined or obtained by the central controller 170. The central controller 170 selects a speed limit for the mover 100 from the speed limits associated with the straight track segment 80l upstream of the curved track segment 84d based on the payload of the mover 100, according to some embodiments. The mover 100 can then be operated to travel along the curved track segment 84d and the straight track segment 80l upstream of the curved track segment 84d according to the selected speed limit.

Advantageously, selecting and applying speed limits to control the rate of travel of movers 100 based on their payload when entering and traveling through curved track segments such as curved track segment 84d can reduce a likelihood of the mover 100 experiencing a tipping moment and reduce a likelihood of product that is carried by the mover 100 being flung from the mover 100. The speed limits based on the upcoming radius of curvature of the next track segment 12 and the payload of the movers 100 can be applied to control a velocity, acceleration, or jerk of the movers 100 prior to entering the curved track segment 84 and while traveling through the curved track segment 84. For example, the movers 100 may be decelerated as set by the speed limit at one or more track segments upstream of the curved track segment 84 in order to ensure that the movers 100 are decelerated in a controlled manner.

It should be understood that all of the track segments 12 of the track 10 can include multiple speed limits. The central controller 170 can track the movement of multiple movers 100 through the track 10 and apply speed limits as desired according to predicted future path of each mover 100 (e.g., when a mover is predicted to be diverted by the junction segments 82), and according to the payload of the movers 100 when approaching track segments 12 having a radius of curvature. Advantageously, the central controller 170 can control the travel of all of the movers 100 simultaneously according to the speed limits of the various track segments 12.

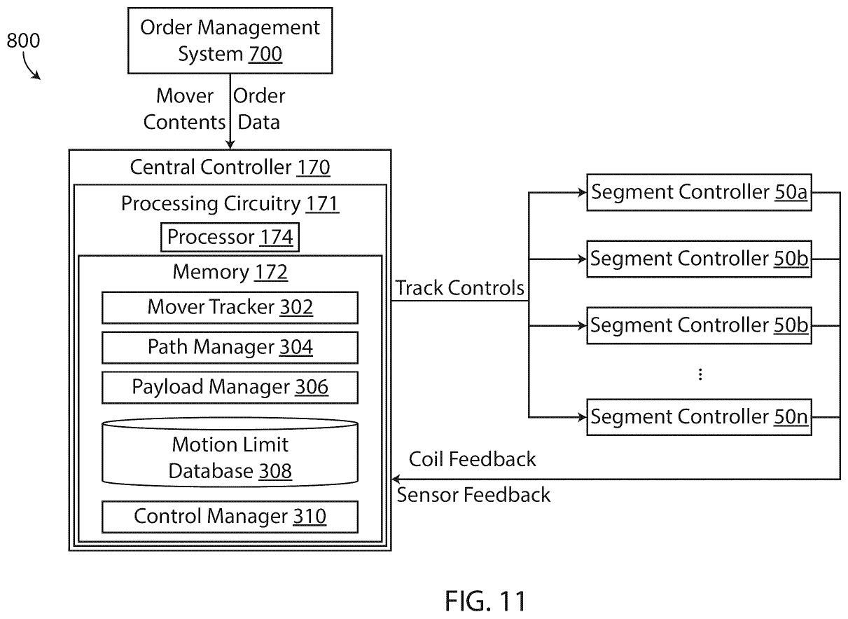

Referring to FIG. 11, among others, a control system 800 for the linear drive system 300 includes the central controller 170 and the segment controllers 50. The control system 800 can also include an order management system 700. The central controller 170 includes processing circuitry including, the processor 174 and memory 172. Processing circuitry 171 can be communicably connected to a communications interface such that processing circuitry 171 and the various components thereof can send and receive data via the communications interface. Processor 174 can be implemented as a general purpose processor, an application specific integrated circuit (ASIC), one or more field programmable gate arrays (FPGAs), a group of processing components, or other suitable electronic processing components.

Memory 172 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 172 can be or include volatile memory or non-volatile memory. Memory 172 can include database components, object code components, script components, or any other type of information structure for supporting the various activities and information structures described in the present application. According to some embodiments, memory 172 is communicably connected to processor 174 via processing circuitry 171 and includes computer code for executing (e.g., by processing circuitry 171 and/or processor 174) one or more processes described herein.

In some embodiments, central controller 170 is implemented within a single computer (e.g., one server, one housing, etc.). In various other embodiments central controller 170 can be distributed across multiple servers or computers (e.g., that can exist in distributed locations) such as on processing circuitry of a cloud computing system.

The central controller 170 can be configured to provide track controls to the segment controllers 50 to cause the segment controllers 50 to energize the coils 150 to drive motion (e.g., travel) of the movers 100. The central controller 170 is configured to receive feedback signals from the segment controllers 50 including coil feedback (e.g., feedback signals from the coils 150) and sensor feedback (e.g., feedback signals from the sensors 145), according to some embodiments.

The central controller 170 includes a mover tracker 302, a path manager 304, a payload manager 306, and a motion limit database 308, and a control manager 310, according to some embodiments. The mover tracker 302 is configured to track the location of movers through the track 10, according to some embodiments. The path manager 304 is configured to track or record a path for each of the movers 100 throughout the track 10, according to some embodiments. The payload manager 306 is configured to estimate or obtain a payload of the movers 100 for use in controlling the rate of travel of the movers 100 along the track 10. The motion limit database 308 is configured to store and apply speed, acceleration, or jerk limits, or more generally, rate of travel limits (e.g., speed limits) for various track segments 12. The control manager 310 is configured to use results of the mover tracker 302 (e.g., the locations of each of the movers 100 through the track 10), the path manager 304 (e.g., paths along which the movers 100 are predicted to travel, a future location of the movers 100, etc.), the payload manager 306 (e.g., estimated payload of the movers 100), and the motion limit database 308 (e.g., the speed limits, acceleration limits, or jerk limits for each track segment 12) in order to generate track controls for the movers 100 to control travel (e.g., rate of travel) of the movers 100. The control manager 310 can generate and provide track controls to the segment controllers 50 which the segment controllers 50 use to energize the coils 150 to induce travel of the movers 100.

The mover tracker 302 is configured to track a current location of each of multiple movers on the track 10, according to some embodiments. In some embodiments, each of the movers 100 has a unique identification. The mover tracker 302 can use coil feedback indicative of a signature of the movers 100 and track a current one of the track segments 12 at which the movers 100 are currently located. The mover tracker 302 can also use the sensor feedback to identify the location of the movers 100 along the track 10. The mover tracker 302 identifies the corresponding track segments 12 at which each of multiple movers 100 are currently located along the track 10, according to some embodiments. In some embodiments, the movers 100 include radio transceivers that are configured to emit signals or respond to wireless signals to report their positions on the track 10. The mover tracker 302 is configured to operate in real-time to track locations of the movers 100 along the track 10, according to some embodiments.

The path manager 304 is configured to maintain a database of path assignments for each of the movers 100, according to some embodiments. In some embodiments, the path manager 304 is configured to store various paths including information of the paths (e.g., which track segments 12 the paths are defined along), and identifications of which of the movers 100 are assigned to the paths. For example, a first set of the movers 100 may be assigned to a first path, a second set of the movers 100 may be assigned to a second path, etc. The paths can include information regarding which track segments 12 the movers 100 are approaching (e.g., a direction of travel and downstream track segments 12 that the movers 100 are moving towards).

The payload manager 306 is configured to determine a payload (e.g., a weight, a size, a number of contents or products that are transported by the movers 100, etc.) of each of the movers 100, according to some embodiments. The payload manager 306 can determine the payload of the movers 100 based on data obtained from a remote system or a fleet management system, shown as the order management system 700, indicating a number of products that are scheduled or ordered to be carried by each of the movers 100. The order management system 700 can receive, process, and schedule orders responsive to user inputs. For example, the payload manager 306 can obtain inventory data from a remote computing system, shown as the order management system 700, that manages product inventory management. The payload manager 306 can use the inventory data that indicates a number of products or contents of each mover 100 to estimate the payload of each mover 100. The payload manager 306 can also use the sensor feedback or the coil feedback obtained from the segment controllers 50 to estimate the payload of each of the movers 100. For example, the payload manager 306 can determine or track a degree of energization of the coils 150 and determine the payload based on a measured amount of movement of the movers 100 and the corresponding degree of energization of the coils 150.

The motion limit database 308 includes a mapping of the track segments 12 and associated speed limits, according to some embodiments. It should be understood that the speed limits can include limits for velocity, acceleration, or a higher order derivative of position than acceleration such as jerk. The motion limit database 308 can include a mapping of the track 10, including multiple speed limits for various track segments 12. The multiple speed limits can be variously included for different curved sections for movers 100 with different payloads. The speed limits for the movers 100 having different payloads can be applied based on the results of the payload manager 306. Similarly, various track segments 12 in the motion limit database 308 such as junction segments 82 can include multiple speed limits that are applied depending on which of multiple future positions or paths the mover 100 is predicted to travel along. In some embodiments, the database 308 includes multiple sub-limits for movers 100 that are applied based on both the predicted future position or paths of the movers 100, and also based on the payload of the movers 100. For example, the motion limit database 308 can include multiple sets of speed limits for the junction 82a corresponding to whether the mover 100 that is approaching the junction segment 82a is predicted to take a curved path along path 88, or a straight path along path 86. The set of speed limits for movers 100 that are predicted to take the curved path along path 88 may have multiple sub-sets of speed limits that can be selected and applied based on the payload of the mover 100. In some embodiments, movers 100 with a lighter payload that are approaching the junction segment 82a that are predicted to curve may have a lower speed limit value than movers 100 that are approaching the junction segment 82a and are predicted to travel straight through the junction segment 82a, but a higher speed limit value (e.g., less speed reduction) than movers 100 with heavier payloads that are predicted to curve along path 88. In this way, the payload-based speed limits and the predicted future path speed limits can be both used to apply appropriate speed limits for movers 100 having various payloads and predicted future paths.

The control manager 310 is configured to use the limits stored in the motion limit database 308, the current positions of the movers 100 as provided by the mover tracker 302, the predicted paths or future positions of the movers 100 as provided by the path manager 304, and the estimated or obtained payload (e.g., weight) of each mover 100 as provided by the payload manager 306, according to some embodiments. The control manager 310 generates track controls for the segment controllers 50 to operate, control, or limit motion of the movers 100 according to speed limits, according to some embodiments. The control manager 310 applies speed limits and controls movement of all of the movers 100 in real-time, according to some embodiments. For example, the control manager 310 can obtain the current position of each of the movers 100 from the mover tracker 302 as well as predicted future locations of the movers 100 from the path manager 304. The control manager 310 can query the motion limit database 308 for speed limits associated with the track segments 12 at which each of the movers 100 are currently located or about to travel onto. If the track segments 12 include multiple speed limits, the control manager 310 selects, from the motion limit database 308, an appropriate speed limit for each of the movers 100 based on the predicted future location or path of the movers 100 and based on the payload of the movers 100. The control manager 310 may generate track controls or setpoints for the segment controllers 50 according to the speed limits and provide the track controls to the segment controllers 50 such that the movers 100, when operated by the segment controllers 50, travel according to or at the speed limit (e.g., limited or reduced velocity, limited or reduced acceleration, or limited or reduced jerk). The control manager 310 is also configured to control operation of the junction members 85 to transition between various states or positions to divert movers 100 along their paths. In some embodiments, the junction members 85 include coils that, when energized, cause a track portion to move between different positions in order to provide a curved path or a straight path through the junction segments 82.

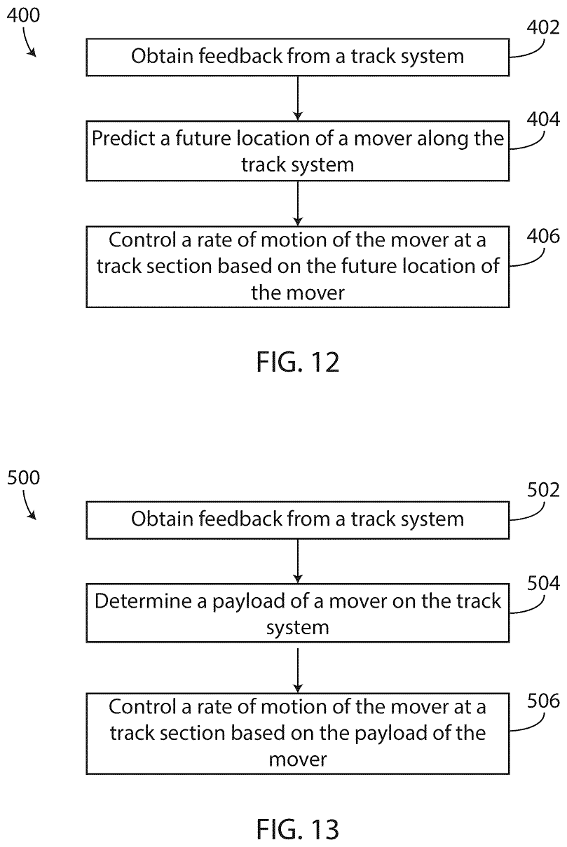

Referring to FIG. 12, among others, a flow diagram of a process 400 (e.g., a method) for controlling operation of movers on a track includes steps 402-406, according to some embodiments. The process 400 can be performed by the central controller 170 and the segment controllers 50. The process 400 can be performed in order to control operation of the coils 150 of the track segments 12 of the track 10 to induce motion of the movers 100 according to preset speed limits. The speed limits advantageously facilitate reduced speed based on a predicted path of the movers 100 (e.g., whether the movers will travel along the first path 86 or the second path 88), according to some embodiments.

The process 400 includes obtaining feedback from a track system (step 402), according to some embodiments. The feedback can include sensor feedback or coil feedback obtained from either the sensors 145 or the coils 150. The feedback can be obtained by the central controller 170 from the segment controllers 50 of the track 10. The feedback can also indicate a payload (e.g., a weight, size, number of products, etc.) of the movers 100.

The process 400 includes predicting a future location of a mover along the track system (step 404), according to some embodiments. The future location of the mover can be determined by the path manager 304 and provided to the control manager 310. The future location of the mover can indicate which of multiple paths through a junction segment that the mover is predicted or set to take. The future location can include an identification of a particular track segment that the mover will travel along once exiting the junction. The future location can be predicted by using a map of the track system and a prediction of which of multiple paths the mover is traveling along. Step 404 can be performed by the central controller 170.

The process 400 includes controlling a rate of motion of the mover at a track section based on the future location of the mover (step 406), according to some embodiments. In some embodiments, step 406 is performed by the control manager 310. The control manager 310 can track the positions of movers throughout the track 10 and query the motion limit database 308 for speed limits associated with each segment or positions of the movers along the track 10. Various sections (e.g., curved sections, sections or segments upstream of a curved section, sections or segments upstream of a junction segment, junction segments, etc.) may include more than one speed limit. Step 406 can include selecting, from the multiple speed limits, a speed limit based on the predicted future location of the mover. For example, a mover that is predicted to curve through a junction segment can be controlled to a lower speed limit than a mover that is predicted to travel straight through the junction segment without turning or experiencing angular momentum. The control manager 310 selects the speed limit based on the predicted future position of the mover, and applies the speed limit by providing track controls to the segment controllers 50. The segment controllers 50 implement the speed limit by energizing coils 150 at the track segments.

Referring to FIG. 13, among others, a flow diagram of a process 500 (e.g., a method) for controlling operation of movers on a track includes steps 502-506, according to some embodiments. The process 500 can be performed by the central controller 170 and the segment controllers 50. The process 500 can be performed in order to control operation of the coils 150 of the track segments 12 of the track 10 to induce motion of the movers 100 according to preset speed limits. The speed limits advantageously facilitate reduced speed based on a payload of the movers 100 along curved sections (e.g., the curved segment 84d) in order to reduce tipping of the movers 100, according to some embodiments.

The process 500 includes obtaining feedback from a track system (step 502), according to some embodiments. The feedback can include sensor feedback or coil feedback obtained from either the sensors 145 or the coils 150. The feedback can be obtained by the central controller 170 from the segment controllers 50 of the track 10. The feedback can also indicate a payload (e.g., a weight, size, number of products, etc.) of the movers 100. In some embodiments, the feedback is obtained from a management system (e.g., order management system 700) that tracks inventory and orders that are fulfilled by the movers 100. The management system can provide scheduled contents of product and corresponding weight for the movers 100.

The process 500 includes determining a payload of a mover on the track system (step 504), according to some embodiments. The payload of the mover can include a weight, a size, or a number of products that are carried by the mover. In some embodiments, the payload is determined based on the feedback obtained in step 502. The payload is obtained by the central controller 170 and used to select or determine appropriate speed limits for the movers 100 at curved track segments or as the movers 100 approach curved track segments.

The process 500 includes controlling a rate of motion of the mover at a track section based on the payload of the mover (step 506), according to some embodiments. Step 506 can be performed by the control manager 310 using the identified or current locations of the movers 100 as provided by the mover tracker 302, the predicted future locations of the movers 100 as provided by the path manager 304, the payload (e.g., weight, size, etc.) of the movers 100 as provided by the payload manager 306, and the speed limits provided by the motion limit database 308 for each track segment 12. For example, the control manager 310 can select, for each mover 100, the speed limits provided by the motion limit database 308 corresponding to the track segments 12 at which the movers 100 are currently located. The control manager 310 can select from multiple speed limits for the track segment 12, if the track segment 12 is associated with multiple speed limits, based on the payload of the mover 100. The control manager 310 can generate track controls for each of the track segments 12 based on the speed limits and provide track controls to the segment controllers 50 for energization of the coils 150. The segment controllers 50 operate the coils 150 to control movement of the movers 100 according to the speed limits.

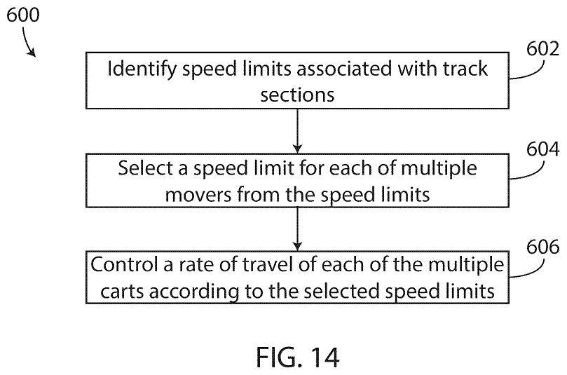

Referring to FIG. 14, a flow diagram of a process 600 (e.g., a method) for controlling operation of movers on a track includes steps 602-606, according to some embodiments. The process 600 can be performed by the central controller 170 and the segment controllers 50. The process 600 can be performed in order to control operation of the coils 150 of the track segments 12 of the track 10 to induce motion of the movers 100 according to preset speed limits. The speed limits advantageously facilitate reduced speed for multiple movers 100 across the entire track 10 in real-time.

The process 600 includes identifying speed limits associated with track sections (step 602), according to some embodiments. The speed limits can be obtained from a database (e.g., the motion limit database 308). The control manager 310 can obtain speed limits associated with the segments 12 of the track 10 at which the movers 100 are currently located, or track segments 12 that the movers 100 are traveling towards (e.g., a next track segment 12). Step 602 can be performed by the control manager 310 by obtaining current locations of the movers 100 from the mover tracker 302 and retrieving speed limits from the motion limit database 308 based on the current locations of the movers 100.

The process 600 includes selecting a speed limit for each of the multiple movers from the speed limits (step 604), according to some embodiments. For example, certain track segments 12 (e.g., the junction segment 82, curved segments 84, etc.) may include multiple speed limits that are applied based on a characteristic of the mover 100 (e.g., a payload of the movers, a predicted future location of the movers 100, a combination thereof, etc.). The step 604 can be performed by the control manager 310 by selecting one of the speed limits for each of the movers 100 from the multiple speed limits. For example, the control manager 310 can select the speed limits from the multiple speed limits based on a payload of the movers 100, a predicted future location of the movers 100 (e.g., which direction the movers 100 will be diverted when traveling through a junction segment 82), or a combination thereof.

The process 600 includes controlling a rate of travel of each of the multiple movers according to the selected speed limits (step 606), according to some embodiments. Step 606 can be performed by the control manager 310 and the segment controllers 50. Step 606 can include determining track controls based on the speed limits selected at step 604 for each of the movers 100 and providing the track controls to the segment controllers 50. The segment controllers 50 use the track controls to energize the coils 150 at the track segments 12 in order to control the movers 100 to travel according to the speed limits.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and components shown in the various exemplary embodiments is illustrative only. Additionally, any element disclosed in one embodiment may be incorporated or utilized with any other embodiment disclosed herein. For example, the techniques and controls of the process 400 of the exemplary embodiment shown in at least FIG. 12 may be incorporated in the process 500 of the exemplary embodiment shown in at least FIG. 13. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for controlling movement of movers, the system comprising:
a track comprising a plurality of interconnected track sections that define a plurality of travel paths and at least one junction at which the plurality of travel paths diverge;
a mover configured to move along the track along a first travel path of the plurality of travel paths, the first travel path comprising at least a first track section of the plurality of track sections upstream of the junction; and
processing circuitry configured to:
predict a future location of the mover along the track based the first travel path of the mover through the junction, the predicted future location comprising either a second track section or a third track section of the plurality of track sections downstream of the junction; and
control a speed of the mover at the first track section based on the predicted future location of the mover, wherein the speed of the mover is controlled to a first speed limit at the first track section if the predicted future location of the mover comprises the second track section and the speed of the mover is controlled to a second speed limit at the first track section if the predicted future location of the mover comprises the third track section.

2. The system of claim 1, wherein the first speed limit is based on a first radius of curvature of the track at the second track section and the second speed limit is based on a second radius of curvature of the track at the third track section.

3. The system of claim 1, wherein the first speed limit is based on a predicted angular acceleration of the mover at the second track section and the second speed limit is based on a predicted angular acceleration of the mover at the third track section.

4. The system of claim 1, wherein the processing circuitry is configured to control the speed of the mover by controlling a velocity, an acceleration, or a jerk of the mover at the first track section based on a characteristic of the track at the second track section or the third track section.

5. The system of claim 1, wherein the mover is a first mover, the predicted future location comprises the second track section, and the first mover is controlled to the first speed limit at the first track section;
the system further comprising a second mover configured to travel along a second travel path of the plurality of travel paths, the second travel path comprising the first track section and the third track section;
wherein the processing circuitry is configured to:
control a speed of the second mover at the first track section according to the second speed limit based on a characteristic of the track at a third track section.

6. The system of claim 1, wherein the first track section comprises a plurality of speed limits including the first speed limit and the second speed limit, the plurality of speed limits having different speed limit values based on characteristics of the track at the second track section and the third track section respectively, and the processing circuitry is configured to select which of the plurality of speed limits to impose at the first track section based on the predicted future location of the mover.

7. The system of claim 1, wherein the track comprises a plurality of coils and the mover comprises drive magnets, wherein the processing circuitry is configured to energize the plurality of coils to induce motion of the mover and control the speed of the mover.

8. The system of claim 1, wherein the processing circuitry is configured to:
predict the future location of the mover based on an ordered route of the mover, or a response from the mover or a management system indicating the first travel path of the plurality of travel paths along which the mover is traveling.

9. A system for controlling movement of movers, the system comprising:
a track comprising a plurality of interconnected track sections defining a travel path;
a mover configured to move along the track along the travel path; and
processing circuitry configured to:
select a speed limit for the mover based on a payload of the mover, the speed limit selected from a plurality of different speed limits associated with a first track section of the plurality of track sections and corresponding to different payloads of the mover; and
control a speed of the mover at the first track section according to the selected speed limit based on the payload of the mover.

10. The system of claim 9, wherein the payload comprises a weight of the mover, a size of the mover, or a quantity of contents of the mover.

11. The system of claim 9, wherein the plurality of speed limits associated with the first track section comprise speed limit values for various values of the payload of the mover.

12. The system of claim 11, wherein the plurality of speed limits have speed limit values for the various values of the payload of the mover such that tipping of the mover is reduced when the mover is controlled according to a corresponding one of the plurality of speed limits.

13. The system of claim 9, wherein the payload of the mover is obtained from a management system that manages orders fulfilled by the mover, or from a load observer.

14. The system of claim 9, wherein the plurality of speed limits have speed limit values that reduce tipping of the mover based on both the payload of the mover and a radius of curvature at the first zone or a predicted future zone of the track towards which the mover is traveling.

15. The system of claim 9, wherein the track comprises a plurality of coils and the mover comprises drive magnets, wherein the processing circuitry is configured to energize the plurality of coils to induce motion of the mover and control the speed of the mover.

16. The system of claim 9, wherein the processing circuitry is configured to control the speed of the mover by controlling a velocity, an acceleration, or a jerk of the mover at the first zone based on the one of the plurality of speed limits associated with the first zone.

17. A method for controlling operation of a plurality of movers on a track comprising a plurality of interconnected track sections, the method comprising:
identifying a plurality of speed limits associated with a first track section of the plurality of track sections;
selecting, for each of the plurality of movers, a speed limit from the plurality of speed limits associated with the first track section, wherein the speed limit for each mover of the plurality of movers is selected based on at least one of a characteristic of the mover or a predicted future location of the mover along the track; and
controlling, for each of the plurality of movers, a rate of travel of the mover along the first track section according to the selected speed limit for the mover.

18. The method of claim 17, wherein the characteristic of the mover comprises a payload of the mover.

19. The method of claim 17, wherein the predicted future location of the mover comprises either a second track section or a third track section of the plurality of track sections and is selected based on a travel path of the mover.

20. The method of claim 17, comprising controlling energization of coils of the track to induce motion of the plurality of movers to control the rate of travel of each of the plurality of movers.
